(19) United States
(12) Patent Application Publication
(10) Pub. No.: US 2010/0207749 A1
(43) Pub. Date: Aug. 19, 2010

(54) Alarm Device of a Bicycle

(76) Inventor: Shen-Mu KAO, Bade City (TW)

Correspondence Address: HDLS IPR Services, PO Box 220746, Chantilly, VA, 20153, US

(21) Appl. No.: 12/636,222

(22) Filed: Dec. 11, 2009

(30) Foreign Application Priority Data
Feb. 17, 2009 (TW) 098202230

(51) Int. Cl. B62J 6/00; G08B 5/22

(52) U.S. Cl. 340/432; 340/815.45

(57) ABSTRACT

An alarm device of a bicycle includes an alarm unit provided on an elbow protector. The alarm unit is able to show a signal which indicates that the bicycle is in a turning status or in a braking status such that a rear driver could know the moving status of the bicycle. The present invention can prevent any accident, enhancing the bicycle driver's safety.

### BACKGROUND OF THE INVENTION

1. Field of the Invention

The present invention relates to an alarm device of a bicycle, and more particularly to an auxiliary alarm device for a bicycle rider.

2. Description of the Prior Art

There are many bicycle accidents recently because bicycles don't have enough alarm equipment. Automobile and motorcycles are equipped with direction lights and brakes lights which can provide a warning effect. However, bicycles don't have such a configuration. It is very dangerous if a bicycle is not equipped with an alarm light. Even though the bicycle is equipped with an alarm light, the conventional alarm light only has a twinkling function, not like a vehicular light which has direction and brake warning functions. Accordingly, the inventor of the present invention has devoted himself based on his many years of practical experiences to solve this problem.

### SUMMARY OF THE INVENTION

The primary object of the present invention is to provide an alarm device of a bicycle rider, warning a rear driver so as to prevent an accident.

According to the present invention, there is provided an alarm device of a bicycle, comprising a direction switch unit mounted on a bicycle handle; a brake sensing unit mounted on the bicycle handle close to a brake grip; a first power source and a first wireless transmission unit which connects with the direction switch unit and the brake sensing unit, respectively; and

an elbow protector comprising a second wireless transmission unit therein, the second wireless transmission unit being adapted to receive a signal from the first wireless transmission unit, the elbow protector further comprising a second power source and an alarm unit, the alarm unit being adapted to show a signal.

The alarm unit of the present invention is disposed on the elbow protector, which is higher than the bicycle. This provides a better warning effect. In general, there are two elbow protectors which are spaced in a proper distance so that other drivers can see the bicycle rider with ease, preventing any bump. Compared to a conventional alarm light which is mounted under a bicycle seat, the present invention has a better warning effect.

### BRIEF DESCRIPTION OF THE DRAWINGS

FIG. 1 is a circuit block diagram of the present invention;

FIG. 2 is a schematic view showing configuration of the present invention;

FIG. 3 is a schematic view showing the present invention in a brake status;

FIG. 4 is a schematic view showing the present invention in a right turn status; and

FIG. 5 is a schematic view showing the present invention in use.

### DETAILED DESCRIPTION OF THE PREFERRED EMBODIMENTS

Embodiments of the present invention will now be described, by way of example only, with reference to the accompanying drawings.

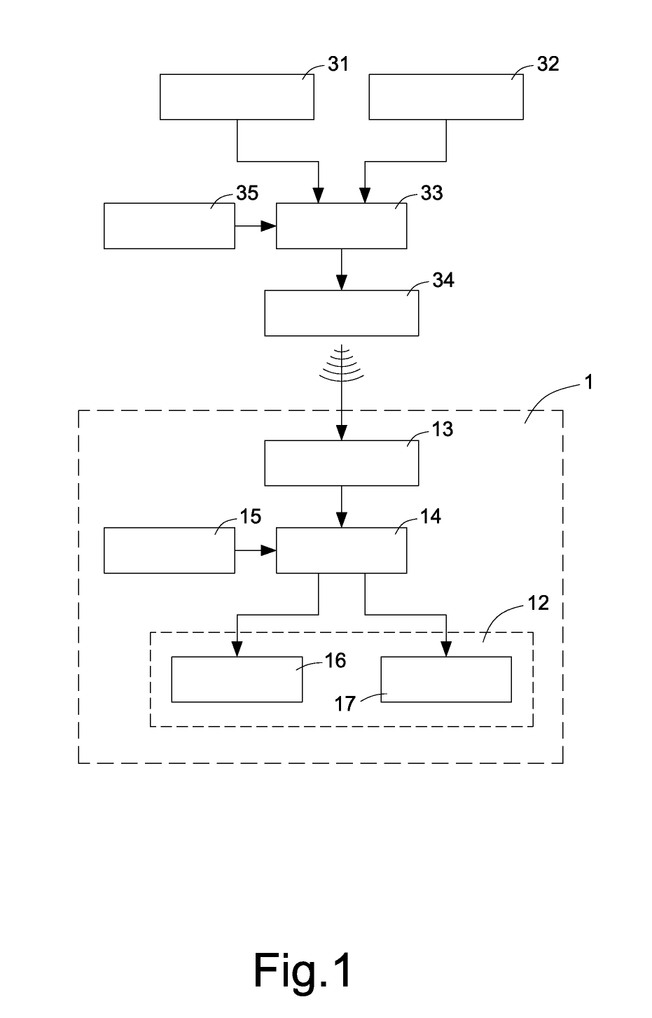

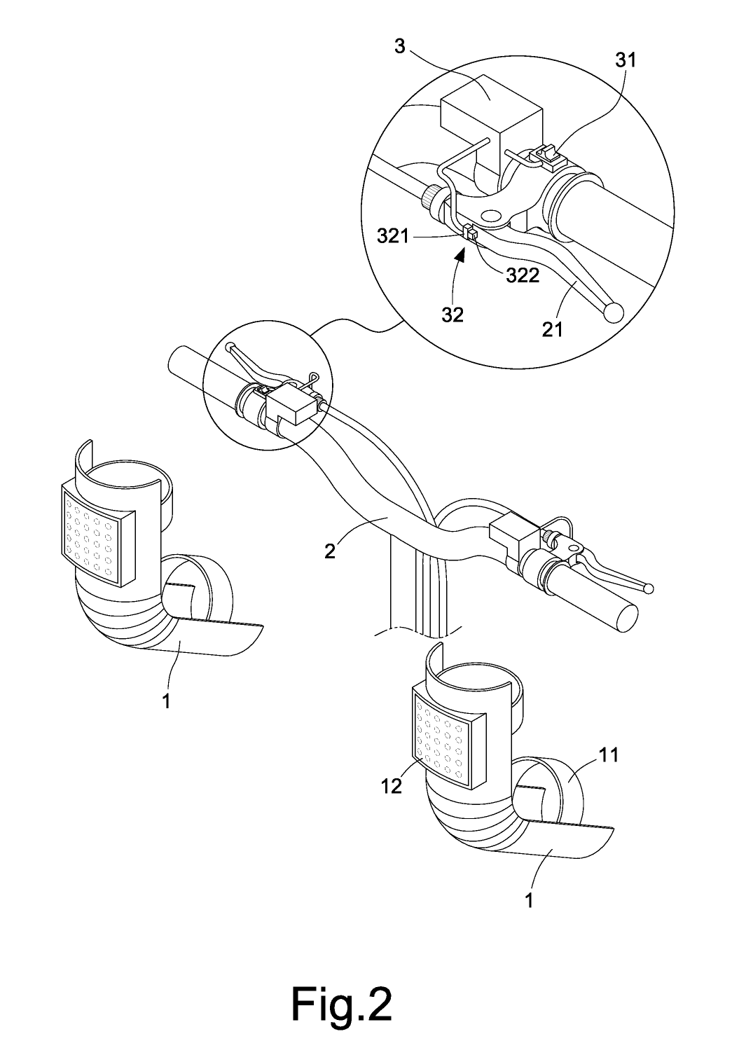

As shown in FIGS. 1 and 2, an alarm device of a bicycle according to a preferred embodiment of the present invention comprises a direction switch unit 31, a brake sensing unit 32, a mainframe 3, and an elbow protector 1.

The direction switch unit 31 is mounted on a bicycle handle 2 for a rider to operate.

The brake sensing unit 32 is mounted on the bicycle handle 2 close to a brake grip 21. The brake sensing unit 32 comprises a first sensing member 321 and a second sensing member 322. The first sensing member 321 is in a fixed state. The second sensing member 322 is movable along with movement of the brake grip 21.

The mainframe 3 is connected with the direction switch unit 31 and the brake sensing unit 32 via wires. The mainframe 3 comprises a control unit 33, a first wireless transmission unit 34, and a first power source 35 therein.

The elbow protector 1 comprises a belt 11 and an alarm unit 12 thereon. The alarm unit 12 is a set of light emitting diodes. The elbow protector 1 comprises a second wireless transmission unit 13 therein for receiving a signal from the first wireless transmission unit 34 of the mainframe 3. The elbow protector 1 further comprises a second power source 15 and a switch unit 14. The alarm unit 12 is able to indicate a direction signal 16 and a brake signal 17.

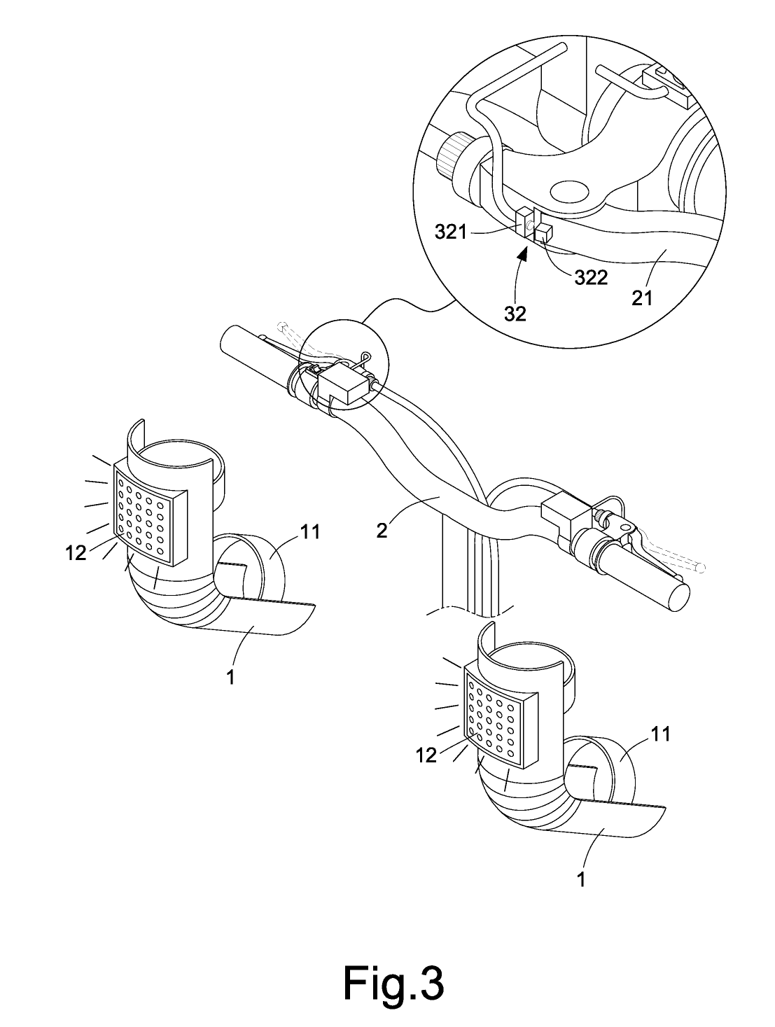

The alarm unit 12 can be lit fully or twinkled slowly to warn other drivers. When the rider brakes his/her bicycle by pulling the brake grip 21, as shown in FIG. 3, the second sensing member 322 will be moved away relative to the first sensing member 321. The mainframe 3 receives a signal which indicates the first sensing member 321 and the second sensing member 322 are separated to know that the bicycle is in a brake status. The first wireless transmission unit 34 sends a signal to the second wireless transmission unit 13 of the elbow protector 1, and the alarm unit 12 shows a signal of deceleration or stop, preventing a rear car from bump.

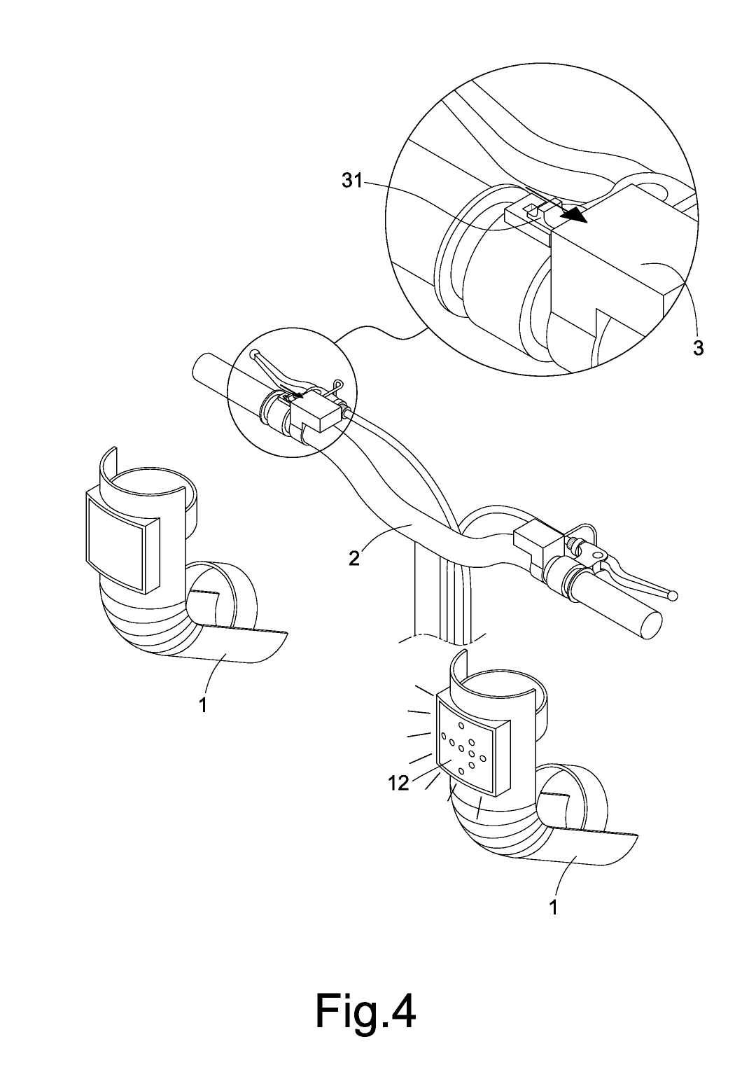

When the rider wants to take a turn, he/she can manually control the direction switch unit 31 on the bicycle handle 2. For example, the direction switch unit 31 is moved right for taking a right turn, as shown in FIG. 4. The mainframe 3 receives a right turn signal from the direction switch unit 31 to command the first wireless transmission unit 34 to send out a signal to be transmitted to the second wireless transmission unit 13 of the elbow protector 1. The alarm unit 12 of the elbow protector 1 on the right hand will show a right turn signal to enhance safety.

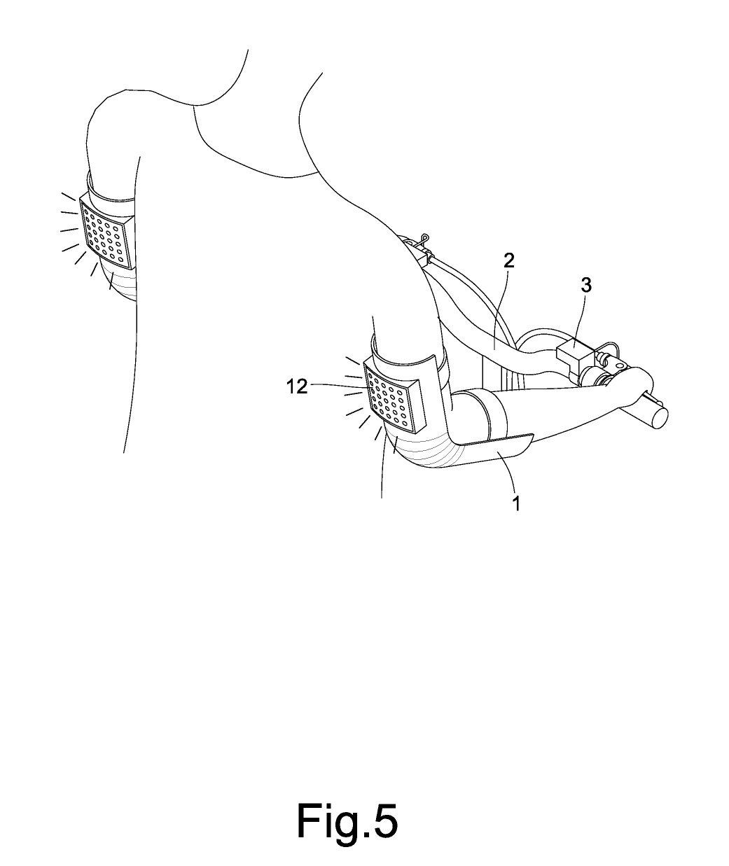

FIG. 5 shows the present invention in use.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. An alarm device of a bicycle, comprising:
a direction switch unit mounted on a bicycle handle;
a brake sensing unit mounted on the bicycle handle close to a brake grip;
a first power source and a first wireless transmission unit which connects with the direction switch unit and the brake sensing unit, respectively; and
an elbow protector comprising a second wireless transmission unit therein, the second wireless transmission unit being adapted to receive a signal from the first wireless transmission unit, the elbow protector further comprising a second power source and an alarm unit, the alarm unit being adapted to show a signal.

2. The alarm device of a bicycle as claimed in claim 1, wherein the brake sensing unit comprises a first sensing member and a second sensing member, the first sensing member being in a fixed state, the second sensing member being movable along with movement of the brake grip.

3. The alarm device of a bicycle as claimed in claim 2, wherein the alarm unit shows a brake signal when the second sensing member is moved away along with movement of the brake grip relative to the first sensing member.

4. The alarm device of a bicycle as claimed in claim 1, wherein the alarm unit shows a direction signal when the direction switch unit is operated.

5. The alarm device of a bicycle as claimed in claim 1, wherein the alarm unit is a set of light emitting diodes.
